(19) United States
(12) Patent Application Publication
(10) Pub. No.: US 2019/0160772 A1
(43) Pub. Date: May 30, 2019

(54) PROTECTIVE STRUCTURE

(71) Applicant: INDUSTRIAL TECHNOLOGY RESEARCH INSTITUTE, Hsinchu (TW)

(72) Inventors: Jiun-You LIOU, Shetou Township (TW); Tsao-Ming PENG, Zhudong Township (TW); Shih-Ming CHEN, Hsinchu City (TW); Wei-Hao LAI, Kaohsiung City (TW); Yu-Tsung CHIU, Taipei City (TW)

(73) Assignee: INDUSTRIAL TECHNOLOGY RESEARCH INSTITUTE, Hsinchu (TW)

(21) Appl. No.: 15/853,266

(22) Filed: Dec. 22, 2017

(30) Foreign Application Priority Data
Nov. 30, 2017 (TW) 106141852

(51) Int. Cl. B29D 99/00; B32B 27/30; C08F 120/06; C08F 120/56; C08F 126/10; H01M 2/02

(52) U.S. Cl. CPC B29D 99/006; C08F 2500/01; C08F 120/06; C08F 120/56; C08F 126/10; H01M 2/02; B32B 2255/10; B32B 2255/26; B32B 2262/0276; B32B 2262/101; B32B 2262/106; B32B 2264/102; B32B 2270/00; B32B 2305/026; B32B 2571/00; B32B 27/30

(57) ABSTRACT

A protective structure is provided, which includes a porous layer and a surface layer disposed on the porous layer. The porous layer includes a first copolymer, a plurality of pores, and a plurality of first silica particles, wherein the first copolymer is polymerized from a first monomer composition. The first monomer composition includes N,N-dimethylacrylamide and N-vinylpyrrolidone. The surface layer includes a second copolymer, a plurality of fibers, and a plurality of second silica particles, wherein the second copolymer is polymerized from a second monomer composition. The second monomer composition includes N,N-dimethylacrylamide and N-vinylpyrrolidone.

### CROSS REFERENCE TO RELATED APPLICATIONS

The present application is based on, and claims priority from, Taiwan Application Serial Number 106141852, filed on Nov. 30, 2017, the disclosure of which is hereby incorporated by reference herein in its entirety.

### TECHNICAL FIELD

The technical field relates to a protective structure, and relates to compositions of a multi-layered structure in the protective structure.

### BACKGROUND

Lithium batteries have several advantages such as a high constant voltage, a high storage energy density, stable discharge, and stable quality. The demand for lithium batteries is increasing daily. While lithium batteries are being applied in a wide variety of popular applications, this carries the risk of accidental burns caused by a high-capacity lithium battery, such as those used in electric vehicles. This safety issue has become an important topic. Materials known for their high level of safety have been introduced into commercially available lithium batteries and soft packages, which may efficiently prevent a thermal runaway reaction from being caused by an internal short-circuit. However, if lithium batteries of the cylindrical type and square type are impacted, punched, or rolled by an external force, this may cause an internal short-circuit that will produce a large amount of heat, thereby dramatically increasing the pressure and possibly causing a leak of flammable electrolyte from a valve. The short-circuit may also produce a spark, and the leaked electrolyte can be ignited by the spark in a conflagration that can gradually heat up and burn neighboring battery sets, thereby starting a series of fires.

Most conventional protective boxes for lithium batteries are made of polypropylene and polycarbonate (PP/PC), polycarbonate and acrylonitrile butadiene styrene (PC/ABS), or stamping steel plate. These have several shortcomings, such as lacking in effective weight-loading ability (or increasing the weight of the battery module), lacking the ability to block external impacts, electrolyte leakage, and poor corrosion resistance. As a result, the number of battery sets that can be contained in a battery box is limited, and this negatively affects the total capacity of the lithium battery module. The endurance of this limited lithium battery module is low, meaning that an electric vehicle employing such batteries is bound to be unpopular. Commercially available battery modules lack a complete protective design, and may suffer the risks of fire and explosion due to impact. In general, protective boxes for lithium batteries focus on sealing and carrying. However, these protective boxes have insufficient stiffness and low shake resistance.

The prior art only partially mitigates the defects of the protective boxes for lithium batteries, and cannot satisfy all of the requirements on electric vehicles (e.g. safety, carrying ability, endurance, corrosion resistance). Accordingly, a protective box made out of a light-weight, electrically insulated, anti-punching, and acid/base corrosion resistant material is called for. The material of the protective box should allow for an increase in the number of battery sets that can be contained in the lithium battery module, lower the weight of the lithium battery module, and block external impacts to reduce the risk of battery failure.

### SUMMARY

One embodiment of the disclosure provides a protective structure, including a porous layer; and a surface layer disposed on the porous layer, wherein the porous layer includes a first copolymer, a plurality of pores, and a plurality of first silica particles, and the first copolymer is polymerized from a first monomer composition including N,N-dimethylacrylamide and N-vinylpyrrolidone, wherein the surface layer includes a second copolymer, a plurality of fibers, and a plurality of second silica particles, and the second copolymer is polymerized from a second monomer composition including N,N-dimethylacrylamide and N-vinylpyrrolidone.

A detailed description is given in the following embodiments.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details.

One embodiment of the disclosure provides a protective structure, includes a porous layer and a surface layer disposed on the porous layer. In one embodiment, the protective structure is a bi-layered structure, such as the porous layer and the surface layer. The porous layer should be near the object to be protected for achieving the protection effect. If the porous layer is disposed at the outside of the protective structure, the surface will be easily cracked due to external impact, thereby degrading the impact resistance of the protective structure. Alternatively, the protective structure is a tri-layered structure, in which the porous layer is disposed between the two surface layers.

The porous layer includes a first copolymer, a plurality of pores, and a plurality of first silica particles, wherein the first copolymer is polymerized from a first monomer. In one embodiment, the first monomer composition includes N,N-dimethylacrylamide (DMAA) and N-vinylpyrrolidone (NVP). For example, DMAA and NVP in the first monomer composition have a weight ratio of 3:1 to 7:1. Too much DMAA results in poor shear strength. Too little DMAA may lower the effects of impact resistance and energy absorption. In one embodiment, the first copolymer has a weight average molecular weight of 1000 to 50000. A first copolymer with an overly high weight average molecular weight may influence a shear thickening glue (STG) response property, thereby lowering the effect of energy absorption. A first copolymer with an overly low weight average molecular weight may cause a problem of leaking the unreacted monomers. In one embodiment, the first monomer composition may include another monomer such as acrylic acid, N-acryloylmorpholine, N,N-diethylacrylamide, or a combination thereof, and the DMAA and the other monomer may have a weight ratio of 3:1 to 7:1. Too much of the other monomer may partially precipitate, and the different monomers do not fully dissolve to each other. In the porous layer, the first silica particles and the first copolymer have a weight ratio of 1.5:1 to 4:1. Too many first silica particles may increase the difficulty of blending process, and the cured and shaped product is easily cracked. Too few silica particles may lose the STG response property. In addition, the porous layer may have 35 to 80 parts by volume of pores. A porous layer with an overly high ratio of the pores lacks structural support, which is easily penetrated by impact to damage the material. A porous layer with an overly low ratio of the pores may lose the compressive ability for absorbing energy, and increase the material weight. In one embodiment, the pores have a diameter of 50 nm to 500 μm. Pores that are too large may form a continuous channel structure, which is not beneficial to the support ability of the porous layer. Pores that are too small lead to a thick, heavy material. In one embodiment, the first silica particles in the porous layer have a diameter of 50 nm to 1 mm. First silica particles that are too large are easily precipitated during blending. If the first silica particles are too small, this may dramatically increase the difficulty of the blending process, and be not beneficial to the pour molding.

The surface layer includes a second copolymer, a plurality of fibers, and a plurality of second silica particles, wherein the second copolymer is polymerized from a second monomer composition. In one embodiment, the second monomer composition includes DMAA and NVP. For example, DMAA and NVP in the second monomer composition may have a weight ratio of 3:1 to 7:1. Too much DMAA results in poor adhesion strength between interfaces of the fibers. Too little DMAA may lower the effects of impact resistance and energy absorption. In one embodiment, the second copolymer has a weight average molecular weight of 1000 to 50000. A second copolymer with an overly high weight average molecular weight may influence its STG response property. A second copolymer with an overly low weight average molecular weight may cause a problem of leaking the unreacted monomers. In one embodiment, the second monomer composition may include another monomer such as acrylic acid, N-acryloylmorpholine, N,N-diethylacrylamide, or a combination thereof, and the DMAA and the other monomer may have a weight ratio of 3:1 to 7:1. Too much of the other monomer may reduce the effects of impact resistance and energy absorption. In the surface layer, the second silica particles and the second copolymer have a weight ratio of 1.5:1 to 4:1. Too many silica particles may increase the difficulty of the blending process. Too few silica particles may lose the STG response property. In one embodiment, the second silica particles in the surface layer have a diameter of 50 nm to 1 mm. Second silica particles that are too large are difficult to disperse in the fibers. Second silica particles that are too small are not beneficial to the fiber immersion. In one embodiment, the fibers in the surface layer can be carbon fibers, glass fibers, Kevlar fibers, polyester fibers, or a combination thereof.

It should be understood that the first monomer composition of the porous layer and the second monomer composition of the surface layer can be the same or different. For example, the DMAA/NVP ratio of the first monomer composition can be different from the DMAA/NVP ratio of the second monomer composition. The type or ratio of other monomer contained in the first monomer composition can be similar to or different from the type or ratio of other monomer contained in the second monomer composition. The weight average molecular weight of the first copolymer and the weight average molecular weight of the second copolymer can be the same or different. Alternatively, the ratio of the first copolymer and the first silica particles in the porous layer can be similar to or different from the ratio of the second copolymer and the second silica particles in the surface layer. The first silica particles in the porous layer and the second silica particles in the surface layer may be the same size or different sizes.

In one embodiment, the surface layer further includes homopolymer, and the second copolymer and the homopolymer have a weight ratio of 1:1 to 7:1. Too high a homopolymer ratio easily causes phase separation and precipitation. In one embodiment, the homopolymer includes poly(vinylpyrrolidone), poly(N,N-dimethylacrylamide), poly(N-isopropylacrylamide), poly(acrylic acid), poly(N,N-diethylacrylamide), or a combination thereof. In one embodiment, the homopolymer is poly(vinylpyrrolidone). In one embodiment, the homopolymer has a weight average molecular weight of 20000 to 100000. A homopolymer with an overly high weight average molecular weight is not beneficial to dispersing and dissolving. A homopolymer with a weight average molecular weight that is too low may possibly leak out.

In the protective structure, the porous layer may have a thickness of 0.5 mm to 1 mm, and the surface layer may have a thickness of 0.5 mm to 1 mm. A porous layer that is too thick results in a plate material that is thick and heavy. A porous layer that is too thin lacks sufficient impact resistance and energy absorption. If the surface layer is too thick, this can result in a thick, heavy plate material. A surface layer that is too thin cannot efficiently dissipate an external impact, thereby allowing cracks to form.

The surface layer may function to dissipate the impact force, block an external punching, and the like. The surface layer is also the main force-withstanding structure, which may increase the flexural strength and the surface tensile strength, and withstand the loading and moment (in the plane) from the external force. In addition, introducing the fabric reinforcing material into the surface layer may achieve light-weight, high intensity, high stiffness, and the like, thereby reducing the weight of the total structure. The porous layer in the protective structure may function as providing energy absorption, shake resistance, and impact resistance, and the like. When an external force is applied to the protective structure, the porous layer may provide flexural strength to avoid the internal material from being damaged by shear. In addition, the porous layer is composed of the light-weight shear thickening prepreg, which may further improve the effects of light-weight and energy absorption. The porous layer can be prepared by pouring a shear thickening fluid (STF) composed of the monomers, the initiator, the silica particles, and the porogen into the mold, and curing the STF to form a porous layer composed of shear thickening glue (STG). The porous layer can be further attached and cured to a surface layer by structural adhesive or the STF, thereby obtaining a protective structure. Alternatively, the surface layer is put into the mold, the STF is poured onto the surface layer in the mold, another surface layer is then put onto the STF, and the STF is then cured to obtain a protective structure containing a porous layer disposed between the two surface layers. This method belongs to an integral formation, which has advantages such as simple, fast, flawless, and the like.

The protective structure can be put onto an object, such that the force applied to the object will be dissipated in the protective structure. The protective structure is mainly applied as a protective shell for lithium batteries to increase the safety of the lithium battery during impact. In addition, the protective structure can be also applied in sport pads, shoe pads, bullet proof vests, and other protective articles. Note that the protective structure can be applied to any suitable object and is not limited to the above applications.

Below, exemplary embodiments will be described in detail so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

### EXAMPLES

### Example 1

13.5 g of silica (Megasil 550 silica, commercially available from Sibelco Asia Pte Ltd.—Bao Lin Branch, diameter=2-3 μm), 5.0 g of N,N-dimethyl dimethylacrylamide (DMAA, CAS#2680-03-7, commercially available from Houchi Chemical Group), 1.0 g of N-vinylpyrrolidone (NVP, CAS#88-12-0, commercially available from Sigma-Aldrich Inc.), 1 phr of a thermal initiator azobisisobutyronitrile (AIBN, on the basis of the total weight of DMAA and NVP), and 0.03 g of a porogen benzene sulfonyl hydrazide (B3809-25G, CAS#80-17-1, commercially available from Sigma-Aldrich Inc.) were poured into a mold, and then heated to 90° C. to react at 90° C. for 1 hour, thereby copolymerizing DMAA and NVP and frothing the copolymer. The copolymer in Example 1 had a weight average molecular weight of about 14752 g/mol. The reaction result was then cooled to form a porous layer. The porous layer was put onto a drill, and the drill contained a pressure sensor. An impact force of 50 J was applied to the porous layer, and the pressure sensor in the drill measured the penetrating force to determine the energy absorption ability of the porous layer. The energy absorption ability was measured using a standard EN1621-1. The density of the porous layer was measured using a standard CNS7407, and the porosity of the porous layer was measured using a standard ISO-15901. The starting materials and the properties of the porous layer are shown in Table 1.

### Example 2

Example 2 was similar to Example 1, and the difference in Example 2 was benzene sulfonyl hydrazide being increased to 0.06 g. The amounts of the silica, DMAA, and NVP and the standards of measuring the properties of the porous layer were similar to those in Example 1. The starting materials and the properties of the porous layer are shown in Table 1.

### Example 3

Example 3 was similar to Example 1, and the difference in Example 3 was benzene sulfonyl hydrazide being increased to 0.12 g. The amounts of the silica, DMAA, and NVP and the standards of measuring the properties of the porous layer were similar to those in Example 1. The starting materials and the properties of the porous layer are shown in Table 1.

### Comparative Example 1

Comparative Example 1 was similar to Example 1, and the difference in Comparative Example 1 was NVP being increased to 6.0 g. The polymer in Comparative Example 1 had a weight average molecular weight of about 13125 g/mol. The amount of the silica and the standards of measuring the properties of the porous layer were similar to those in Example 1. The starting materials and the properties of the porous layer are shown in Table 1.

### Comparative Example 2

Comparative Example 2 was similar to Example 1, and the difference in Comparative Example 2 was benzene sulfonyl hydrazide being increased to 0.2 g. The amounts of the silica, DMAA, and NVP and the standards of measuring the properties of the porous layer were similar to those in Example 1. The starting materials and the properties of the porous layer are shown in Table 1.

TABLE 1

| | Porous layer | | | | | | | |
|---|---|---|---|---|---|---|---|---|
| | Composition (g) | | | | | | | |
| | | | | Benzene | | Impact test | | |
| | | | | sulfonyl | Thickness | Penetrating force | Density | Porosity |
| | Silica | DMAA | NVP | hydrazide | (mm) | (kN) | (g/ml) | (%) |
| Example 1 | 13.5 | 5.0 | 1.0 | 0.03 | 2.9 | 16.57 | 1.12 | 38% |
| Example 2 | 13.5 | 5.0 | 1.0 | 0.06 | 3.0 | 17.01 | 0.50 | 70% |
| Example 3 | 13.5 | 5.0 | 1.0 | 0.12 | 3.2 | 21.12 | 0.31 | 77% |
| Comparative | 13.5 | 6.0 | 0 | 0.03 | 3.2 | Not available* | 1.2 | 33% |
| Example 1 | | | | | | | | |
| Comparative | 13.5 | 5.0 | 1.0 | 0.2 | 3.6 | Not available* | 0.25 | 80% |
| Example 2 | | | | | | | | |

*The porous layer cracked in the impact test

As shown in Table 1, the porous layers of the monomer composition without NVP cracked in the impact test. On the other hand, the porous layer formed by too much porogen was too thick and porous (e.g. overly low density), and also cracked in the impact test.

### Example 4

13.5 g of silica, 5.0 g of DMAA, 1.0 g of NVP, 1 phr of the thermal initiator AIBN (on the basis of the total weight of DMAA and NVP) were poured into a mold, and then heated to 90° C. to react at 90° C. for 1 hour, thereby copolymerizing DMAA and NVP. The reaction result was then cooled to form a prepreg of a surface layer (without fibers). The prepreg of the surface layer was put onto a drill, and the drill contained a pressure sensor. An impact force of 50 J was applied to the prepreg of the surface layer, and the pressure sensor in the drill measured the penetrating force to determine the energy absorption ability of the prepreg of the surface layer. The shear strength of the prepreg of the surface layer was measured using a standard ASTM D624. The starting materials of the prepreg and the properties of the surface layer are shown in Table 2.

### Example 5

Example 5 was similar to Example 4, and the difference in Example 5 was the starting materials further comprising 1.0 g of acrylic acid (AA). The copolymer in Example 5 had a weight average molecular weight of about 11251 g/mol. The amounts of the silica, DMMA, and NVP, and the standards of measuring the prepreg properties were similar to those in Example 4. The starting materials and the properties of the prepreg of the surface layer are shown in Table 2.

### Comparative Example 3

Comparative Example 3 was similar to Example 4, and the difference in Comparative Example 3 was NVP being omitted and DMAA being increased to 6.0 g. The polymer in Comparative Example 3 had a weight average molecular weight of about 13892 g/mol. The amount of the silica and the standards of measuring the prepreg properties were similar to those in Example 4. The starting materials and the properties of the prepreg of the surface layer are shown in Table 2.

### Comparative Example 4

Comparative Example 4 was similar to Example 4, and the differences in Comparative Example 4 were DMAA being decreased to 1.0 g and NVP being increased to 5.0 g. The polymer in Comparative Example 4 had a weight average molecular weight of about 17230 g/mol. The amount of the silica and the standards of measuring the prepreg properties were similar to those in Example 4. The starting materials and the properties of the prepreg of the surface layer are shown in Table 2.

### Comparative Example 5

Comparative Example 5 was similar to Example 4, and the difference in Comparative Example 5 was NVP (5.0 g) being replaced with AA (5.0 g). The amounts of the silica and DMAA and the standards of measuring the prepreg properties were similar to those in Example 4. The starting materials and the properties of the prepreg of the surface layer are shown in Table 2.

### Comparative Example 6

Comparative Example 6 was similar to Example 4, and the difference in Comparative Example 6 was NVP (5.0 g) being replaced with N-acryloylmorpholine (5.0 g, ACMO, CAS#5117-12-4, commercially available from Houchi Chemical Group). The amounts of the silica and DMAA and the standards of measuring the prepreg properties were similar to those in Example 4. The starting materials and the properties of the prepreg of the surface layer are shown in Table 2.

TABLE 2

| | Prepreg of surface layer (without fibers) | | | | | | | |
|---|---|---|---|---|---|---|---|---|
| | Composition (g) | | | | | Thickness | Impact test | Shear strength test |
| | Silica | DMAA | NVP | AA | ACMO | (mm) | Penetrating force (kN) | Shear strength (kPa) |
| Example 4 | 13.5 | 5.0 | 1.0 | 0 | 0 | 3.0 | 16.37 | 40 |
| Example 5 | 13.5 | 4.0 | 1.0 | 1.0 | 0 | 3.0 | 17.42 | 31 |
| Comparative | 13.5 | 6.0 | 0 | 0 | 0 | 3.0 | 16.27 | 16 |
| Example 3 | | | | | | | | |
| Comparative | 13.5 | 1.0 | 5.0 | 0 | 0 | 3.0 | 25.12 | 60 |
| Example 4 | | | | | | | | |
| Comparative | 13.5 | 1.0 | 0 | 5.0 | 0 | 3.0 | 23.17 | 40 |
| Example 5 | | | | | | | | |
| Comparative | 13.5 | 1.0 | 0 | 0 | 5.0 | 3.0 | 26.32 | 55 |
| Example 6 | | | | | | | | |

As shown in the comparison of Table 2, appropriate ratios of the DMAA and NVP could simultaneously satisfy the requirements for impact resistance and shear strength of the prepreg of the surface layer. The monomer composition without NVP (e.g. Comparative Example 3) would dramatically reduce the shear strength of the prepreg of the surface layer. Too little DMAA (e.g. Comparative Examples 4 to 6) results in an overly high penetrating force through the prepreg of the surface layer.

### Example 6

8 layers of carbon fibers (TC-36 12K, commercially available from Formosa plastic cooperation) were put into a mold. 13.5 g of silica, 5.0 g of DMAA, 1.0 g of NVP, 1 phr of the thermal initiator AIBN (on the basis of the total weight of DMAA and NVP) were poured into the mold, and then heated to 90° C. to react at 90° C. for 1 hour, thereby copolymerizing DMAA and NVP. The reaction result was then cooled to form a surface layer. The shear strength of the surface layer was measured using the standard ASTM D3163. The starting materials of the prepreg and the properties of the surface layer are shown in Table 3.

### Example 7

Example 7 was similar to Example 6, and the difference in Example 7 was 1 g of homopolymer poly(DMMA) (773638, commercially available from Sigma-Aldrich Inc.) was further added to the mold. The amounts of the silica, the DMAA, and the NVP, and the standard of measuring the surface layer properties were similar to those in Example 6. The starting materials of the prepreg and the properties of the surface layer are shown in Table 3.

### Example 8

Example 8 was similar to Example 6, and the difference in Example 8 was 1 g of homopolymer poly(NVP) (856568G, CAS#9003-39-8, commercially available from Sigma-Aldrich Inc.) was further added to the mold. The amounts of the silica, the DMAA, and the NVP, and the standard of measuring the surface layer properties were similar to those in Example 6. The starting materials of the prepreg and the properties of the surface layer are shown in Table 3.

### Example 9

Example 9 was similar to Example 6, and the difference in Example 9 was 1 g of homopolymer poly(AA) (P3981-AA, commercially available from Polymer Source Inc.) was further added to the mold. The amounts of the silica, the DMAA, and the NVP, and the standard of measuring the surface layer properties were similar to those in Example 6. The starting materials of the prepreg and the properties of the surface layer are shown in Table 3.

### Comparative Example 7

Comparative Example 7 was similar to Example 6, and the difference in Comparative Example 7 was NVP being omitted and DMAA being increased to 6.0 g. The amount of the silica and the standard of measuring the surface layer properties were similar to those in Example 6. The starting materials of the prepreg and the properties of the surface layer are shown in Table 3.

### Comparative Example 8

Comparative Example 8 was similar to Example 7, and the difference in Comparative Example 8 was 1 g of the homopolymer poly(DMAA) (773638, commercially available from Sigma-Aldrich Inc.) was further added to the mold. The amount of the silica and the standard of measuring the surface layer properties were similar to those in Example 6. The starting materials of the prepreg and the properties of the surface layer are shown in Table 3.

### Comparative Example 9

Comparative Example 9 was similar to Example 7, and the difference in Comparative Example 9 was 1 g of the homopolymer poly(NVP) (856568-100G, CAS#9003-39-8, commercially available from Sigma-Aldrich Inc.) was further added to the mold. The amount of the silica and the standard of measuring the surface layer properties were similar to those in Example 6. The starting materials of the prepreg and the properties of the surface layer are shown in Table 3.

### Comparative Example 10

Comparative Example 10 was similar to Example 7, and the difference in Comparative Example 10 was 1 g of the homopolymer poly(AA) (323667-100G, CAS#9003-01-4, commercially available from Sigma-Aldrich Inc.) was further added to the mold. The amount of the silica and the standard of measuring the surface layer properties were similar to those in Example 6. The starting materials of the prepreg and the properties of the surface layer are shown in Table 3.

TABLE 3

| | Surface layer | | | | | |
|---|---|---|---|---|---|---|
| | | | | | | Shear |
| | | | | | | test |
| | | | | | Thick- | Shear |
| | Composition (g) | | | Homopolymer | ness | strength |
| | Silica | DMAA | NVP | (g) | (mm) | (MPa) |
| Example 6 | 13.5 | 5.0 | 1.0 | 0 | 0.8 | 458 |
| Example 7 | 13.5 | 5.0 | 1.0 | Poly(DMAA) | 0.8 | 471 |
| | | | | (1) | | |
| Example 8 | 13.5 | 5.0 | 1.0 | Poly(NVP) | 0.8 | 576 |
| | | | | (1) | | |
| Example 9 | 13.5 | 5.0 | 1.0 | Poly(AA) (1) | 0.8 | 492 |
| Comparative | 13.5 | 6.0 | 0 | 0 | 0.8 | 375 |
| Example 7 | | | | | | |
| Comparative | 13.5 | 6.0 | 0 | Poly(DMAA) | 0.8 | 402 |
| Example 8 | | | | (1) | | |
| Comparative | 13.5 | 6.0 | 0 | Poly(NVP) (1) | 0.8 | 418 |
| Example 9 | | | | | | |
| Comparative | 13.5 | 6.0 | 0 | Poly(AA) (1) | 0.8 | 417 |
| Example 10 | | | | | | |

As shown in the comparison of Table 3, the homopolymer may further increase the shear strength of the surface layer. However, if the monomer composition of the copolymer lacked NVP, the homopolymer could not help the surface layer achieve sufficient shear strength.

### Example 10

8 layers of the carbon fibers (TC-36 12K, commercially available from Formosa plastic cooperation) were put into a mold. 13.5 g of silica, 5.0 g of DMAA, 1.0 g of NVP, 1 phr of the thermal initiator AIBN (on the basis of the total weight of DMAA and NVP), and 1 g of the homopolymer poly(NVP) were poured into the mold, and then heated to 90° C. to react at 90° C. for 1 hour, thereby copolymerizing DMAA and NVP. The reaction result was then cooled to form a surface layer. The above steps were repeated again to obtain another surface layer.

13.5 g of silica, 5.0 g of DMAA, 1.0 g of NVP, 1 phr of the thermal initiator AIBN (on the basis of the total weight of DMAA and NVP), and 0.06 g of porogen benzene sulfonyl hydrazide (B3809-25G, CAS#80-17-1, commercially available from Sigma-Aldrich Inc.) were poured onto the surface in the mold to serve as a formula of porous layer, and the other surface layer was put onto the formula of porous layer. The formula of porous layer was heated to 90° C. to react at 90° C. for 1 hour, thereby copolymerizing DMAA and NVP and frothing the copolymer. The reaction result was then cooled to form a porous layer between the two surface layers, thereby obtaining a tri-layered protective structure. Clay with a thickness of 30 mm was attached onto the surface layer, and a steel round head (weight of 110.4 g and volume of 14.29 cm³) was disposed onto the other surface layer, in which the protective structure was disposed between the clay and the steel round head. The steel round head was then bumped by a golf ball (having a diameter of 42.67 mm) with a velocity of 48 m/s, such that the steel round head with a velocity of 25 m/s impacted the protective structure. Thereafter, the recess depth and recess volume of the clay and the recess depth of the protective structure were measured, and the appearance of the protective structure was observed, as shown in Table 4.

### Example 11

Example 11 was similar to Example 10, and the difference in Example 11 was the 8 layers of the carbon fibers in the surface layers being replaced with 8 layers of the glass fibers (E-glass 2116, commercially available from Golden Tsai Hsing Co., Ltd.). The other compositions in the surface layer, the composition of the porous layer, and the method of measuring the protective structure properties were similar to those in Example 10. The compositions of the protective structure are shown in Table 4. In addition, the recess depth and recess volume of the clay, the recess depth of the protective structure, and the appearance of the protective structure after the impact test are shown in Table 4.

### Example 12

Example 12 was similar to Example 10, and the difference in Example 12 was one surface layer being omitted to obtain a bi-layered protective structure. The composition of the surface layer, the composition of the porous layer, and the method of measuring the protective structure properties were similar to those in Example 10. In the impact test of this example, the clay was in contact with the porous layer, and the steel round head was in contact with the surface layer. The compositions of the protective structure are shown in Table 4. In addition, the recess depth and recess volume of the clay, the recess depth of the protective structure, and the appearance of the protective structure after the impact test are shown in Table 4.

### Example 13

Example 13 was similar to Example 11, and the difference in Example 13 was one surface layer being omitted to obtain a bi-layered protective structure. The composition of the surface layer, the composition of the porous layer, and the method of measuring the protective structure properties were similar to those in Example 10. In the impact test of this example, the clay was in contact with the porous layer, and the steel round head was in contact with the surface layer. The compositions of the protective structure are shown in Table 4. In addition, the recess depth and recess volume of the clay, the recess depth of the protective structure, and the appearance of the protective structure after the impact test are shown in Table 4.

### Comparative Example 11 (Blank Test)

The impact test was directly performed without the protective structure, in which the steel round head impacted the clay. The recess depth and recess volume of the clay are shown in Table 4.

### Comparative Example 12

Commercially available steel plate SS41 was serving as a protective structure for the impact test. The composition of the protective structure is shown in Table 4. In addition, the recess depth and recess volume of the clay, the recess depth of the protective structure, and the appearance of the protective structure after the impact test are shown in Table 4.

### Comparative Example 13

The surface layer in Example 10 was serving as the intermediate layer of the protective structure, and the porous layer in Example 10 was serving as the two surface layers of the protective structure. The compositions of the protective structure are shown in Table 4. In addition, the recess depth and recess volume of the clay, the recess depth of the protective structure, and the appearance of the protective structure after the impact test are shown in Table 4.

### Comparative Example 14

The surface layer in Example 11 was serving as the intermediate layer of the protective structure, and the porous layer in Example 11 was serving as the two surface layers of the protective structure. The compositions of the protective structure are shown in Table 4. In addition, the recess depth and recess volume of the clay, the recess depth of the protective structure, and the appearance of the protective structure after the impact test are shown in Table 4.

### Comparative Example 15

The porous layer in Example 10 was serving as the protective structure for the impact test. The composition of the protective structure is shown in Table 4. In addition, the recess depth and recess volume of the clay, the recess depth of the protective structure, and the appearance of the protective structure after the impact test are shown in Table 4.

### Comparative Example 16

Referring to Example 3 in U.S. Publication No. 20170174930, 13.5 g of silica, 6.0 g of DMAA, and 1 phr of the AIBN (on the basis of the weight of the DMAA) were added into a mold, and then heated to 90° C. to react at 90° C. for 1 hour to polymerize the DMAA. The reaction result was cooled to obtain a protective structure for the impact test. The composition of the protective structure is shown in Table 4. In addition, the recess depth and recess volume of the clay, the recess depth of the protective structure, and the appearance of the protective structure after the impact test are shown in Table 4.

### Comparative Example 17

Referring to Example 22 in Taiwan Publication No. 201722734A, a steric fabric was put into a mold. 13.5 g of silica, 6.0 g of DMAA, and 1 phr of the AIBN (on the basis of the weight of the DMAA) were added into the mold, and then heated to 90° C. to react at 90° C. for 1 hour to polymerize the DMAA. The reaction result was cooled to obtain a protective structure for the impact test. The composition of the protective structure is shown in Table 4. In addition, the recess depth and recess volume of the clay, the recess depth of the protective structure, and the appearance of the protective structure after the impact test are shown in Table 4.

### Comparative Example 18

Comparative Example 18 was similar to Example 10, and the difference in Comparative Example 18 was the middle layer being replaced with PU foam (two-liquid type PU foam UR-370, commercially available from KLS Cooperation). The composition of the surface layer and the method of measuring the protective structure properties were similar to those in Example 10. The compositions of the protective structure are shown in Table 4. In addition, the recess depth and recess volume of the clay, the recess depth of the protective structure, and the appearance of the protective structure after the impact test are shown in Table 4.

TABLE 4

| | | | | | Recess depth | | | |
|---|---|---|---|---|---|---|---|---|
| | | | | Thickness of | of the | Recess | Recess | |
| | Protective structure | | | protective | protective | depth | volume | Appearance |
| | | | Bottom | structure | structure | of clay | of clay | of protective |
| | Top layer | Middle layer | layer | (mm) | (mm) | (mm) | (mL) | structure |
| Example 10 | Surface | Porous layer | Surface | 2.38 | <0.20 | 0.30 | 1.00 | Intact |
| | layer | | layer | (0.79 + 0.8 + 0.79) | | | | surface |
| | containing 8 | | containing 8 | | | | | |
| | layers of | | layers of | | | | | |
| | carbon | | carbon | | | | | |
| | fibers | | fibers | | | | | |
| Example 11 | Surface | Porous layer | Surface | 2.02 | <0.30 | 0.35 | 1.50 | Intact |
| | layer | | layer | (0.71 + 0.6 + 0.71) | | | | surface |
| | containing 8 | | containing 8 | | | | | |
| | layers of | | layers of | | | | | |
| | glass fibers | | glass fibers | | | | | |
| Example 12 | Surface | Porous layer | | 1.31 | <0.30 | 0.40 | 1.60 | Intact |
| | layer | | | (0.61 + 0.7) | | | | surface |
| | containing 8 | | | | | | | |
| | layers of | | | | | | | |
| | carbon | | | | | | | |
| | fibers | | | | | | | |
| Example 13 | Surface | Porous layer | | 1.28 | <0.40 | 0.50 | 1.70 | Intact |
| | layer | | | (0.58 + 0.7) | | | | surface |
| | containing 8 | | | | | | | |
| | layers of | | | | | | | |
| | glass fibers | | | | | | | |
| Comparative | No protective structure | | | Zero | None | 14.26 | 15.00 | No |
| Example 11 | | | | | | | | |
| Comparative | SS41 steel plate | | | 1.03 | 5.09 | 5.11 | 4.00 | Recess |
| Example 12 | | | | | | | | |
| Comparative | Porous layer | Surface | Porous layer | 2.42 | >0.5 | 0.60 | 2.00 | Crack |
| Example 13 | | layer | | (0.8 + 0.82 + 0.8) | | | | surface |
| | | containing 8 | | | | | | |
| | | layers of | | | | | | |
| | | carbon | | | | | | |
| | | fibers | | | | | | |
| Comparative | Porous layer | Surface | Porous layer | 2.2 | >0.55 | 0.65 | 2.50 | Crack |
| Example 14 | | layer | | (0.7 + 0.8 + 0.7) | | | | surface |
| | | containing 8 | | | | | | |
| | | layers of | | | | | | |
| | | glass fibers | | | | | | |
| Comparative | Porous layer | | | 2 | Not | 5.15 | 6.00 | Crack |
| Example 15 | | | | | available | | | |
| Comparative | US20170174930 | | | 2.00 | Not | 14 | 14.50 | Crack |
| Example 16 | | | | | available | | | |
| Comparative | TW201722734A | | | 3.70 | 2.10 | 2.30 | 3.00 | Crack |
| Example 17 | | | | | | | | surface |
| Comparative | Surface | PU foam | Surface | 2.2 | >0.5 | 0.60 | 2.00 | Crack |
| Example 18 | layer | | layer | (0.7 + 0.8 + 0.7) | | | | surface |
| | containing 8 | | containing 8 | | | | | |
| | layers of | | layers of | | | | | |
| | carbon | | carbon | | | | | |
| | fibers | | fibers | | | | | |

As shown in Table 4, the combination of the porous layer and the surface layer had an impact-resistance effect, but the protective structure with the porous layer on the outer side had problems with the surface cracking. The protective properties of the porous layer (without the surface layer) had a poor impact resistance effect. If the surface layer was collocated with another porous layer (e.g. general PU foam) rather than the porous layer of the disclosure, the protective structure would have poor impact resistance, too. It should be understood that the protective structure of the surface layer (without the porous layer) may have had a worse effect on impact resistance.

It will be apparent to those skilled in the art that various modifications and variations can be made to the disclosed methods and materials. It is intended that the specification and examples be considered as exemplary only, with the true scope of the disclosure being indicated by the following claims and their equivalents.

What is claimed is:

1. A protective structure, comprising:
a porous layer; and a surface layer disposed on the porous layer,
wherein the porous layer includes a first copolymer, a plurality of pores, and a plurality of first silica particles, and the first copolymer is polymerized from a first monomer composition including N,N-dimethylacrylamide and N-vinylpyrrolidone,
wherein the surface layer includes a second copolymer, a plurality of fibers, and a plurality of second silica particles, and the second copolymer is polymerized from a second monomer composition including N,N-dimethylacrylamide and N-vinylpyrrolidone.

2. The protective structure as claimed in claim 1, wherein the porous layer includes 35 parts by volume to 85 parts by volume of pores, and the pores have a diameter of 50 nm to 500 μm.

3. The protective structure as claimed in claim 1, wherein N,N-dimethylacrylamide and N-vinylpyrrolidone in the first monomer composition have a weight ratio of 3:1 to 7:1, and N,N-dimethylacrylamide and N-vinylpyrrolidone in the second monomer composition have a weight ratio of 3:1 to 7:1.

4. The protective structure as claimed in claim 1, wherein the first silica particles and the first copolymer have a weight ratio of 1.5:1 to 4:1, and the second silica particles and the second copolymer have a weight ratio of 1.5:1 to 4:1.

5. The protective structure as claimed in claim 1, wherein the first monomer composition further comprises acrylic acid, N-acryloylmorpholine, N,N-diethylacrylamide, or a combination thereof; and/or the second monomer composition further comprises acrylic acid, N-acryloylmorpholine, N,N-diethylacrylamide, or a combination thereof.

6. The protective structure as claimed in claim 1, wherein the first copolymer has a weight average molecular weight of 1000 to 50000, and/or the second copolymer has a weight average molecular weight of 1000 to 50000.

7. The protective structure as claimed in claim 1, wherein the surface layer further comprises a homopolymer, and the second copolymer and the homopolymer have a weight ratio of 1:1 to 7:1.

8. The protective structure as claimed in claim 7, wherein the homopolymer comprises poly(vinylpyrrolidone), poly(N,N-dimethylacrylamide), poly(N-isopropylacrylamide), poly(acrylic acid), poly(N,N-diethylacrylamide), or a combination thereof.

9. The protective structure as claimed in claim 7, wherein the homopolymer has a weight average molecular weight of 20000 to 100000.

10. The protective structure as claimed in claim 1, wherein the first silica particles and the second silica particles have a diameter of 50 nm to 1 mm.

11. The protective structure as claimed in claim 1, wherein the fibers comprise carbon fibers, glass fibers, Kevlar fibers, polyester fibers, or a combination thereof.

12. The protective structure as claimed in claim 1, wherein the porous layer has a thickness of 0.5 mm to 1 mm, and the surface layer has a thickness of 0.5 mm to 1 mm.
